(19) United States
(12) Patent Application Publication
(10) Pub. No.: US 2005/0270377 A1
(43) Pub. Date: Dec. 8, 2005

(54) Connecting configuration of a remote camera

(75) Inventor: Yi-Chuan Liu, Jhonghe City (TW)

Correspondence Address: O'rite Technology Co., Ltd., P.O. Box No. 6-57, Junghe, Taipei, 235, TW

(73) Assignee: O'rite Technology Co., Ltd.

(21) Appl. No.: 11/132,369

(22) Filed: May 19, 2005

(30) Foreign Application Priority Data
Jun. 4, 2004 (TW) 093208808

(51) Int. Cl. H04N 5/225

(52) U.S. Cl. 348/207.99

(57) ABSTRACT

A connecting configuration of a remote camera includes a camera and an extension line connected to the camera. The camera has a PCB with a connector formed at the PCB. The extension line has a housing at one end thereof and a complementary connector at the other end thereof for connecting with the connector of the PCB. An RJ-45 port and a DC port are disposed in the housing and respectively connecting with the extension line. Signals from the RJ-45 port and the DC port are transmitted to the connector of the PCB through the extension line. Therefore the RJ-45 port and the DC port are separated from the camera for facilitating to reduce the volume of the camera.

### BACKGROUND OF THE INVENTION

(a) Field of the Invention

The present invention relates to a connecting configuration of a remote camera, and particularly to a connecting configuration which separates an RJ-45 port from a remote camera through an extension line thereby reducing the volume of the camera.

(b) Description of the Prior Art

Due to a relatively longer distance between a remote camera and a computer electrically connected to the camera, a universal serial port or a USB line (USB has a transmitting distance limitation of 5 meters) cannot be used to transmit data from the camera to the computer. A cable (such as a cable of cable TV) or an RCA extension line is used to transmit data from the camera to the computer. However, the quality of the cable or the RCA extension line, and the signal attenuation due to long distance transmission are problems to be considered when the remote camera is designed.

As the development of wideband network, a network line is used to connect the remote camera to the computer for encountering the above problems. After the remote camera is connected to the network, video captured by the camera can be viewed through inputting IP address of the camera in a web browser (such as Microsoft IE).

Referring to FIG. 4, a conventional remote camera 10 is defined with an RJ-45 port 101 at a PCB for providing connection with a network line. The RJ-45 port 101 is connected with a transformer disposed at the PCB whereby control signals and video data can be transmitted between the remote camera and the computer through the network line. However, the RJ-45 port 101 is a limitation to effectively reduce the volume of the PCB and the camera.

### SUMMARY OF THE INVENTION

Accordingly, an object of the present invention is to provide a connecting configuration of a remote camera which employs an extension line to connect a communication port of the remote camera at one end thereof and to connect an RJ-45 port at the other end thereof whereby the RJ-45 port is separated from the camera for reducing the volume of a PCB of the camera.

Another object of the present invention is to provide a connecting configuration of a remote camera which combines an RJ-45 port and a DC port to assemble in a housing disposed at one end of an extension line and to respectively electrically connect the extension line whereby signals from the RJ-45 port and the DC port are transmitted to a connector disposed at the other end of the extension line, when the connector connects to a PCB of the camera, data transmission between the RJ-45 port or the DC port and the camera is accomplished, and so it is ready to reduce the volume of the camera since the RJ-45 port is separated from the camera.

Other objects, advantages and novel features of the present invention will be drawn from the following detailed embodiment of the present invention with attached drawings, in which:

### BRIEF DESCRIPTION OF THE DRAWINGS

FIG. 1 is a perspective view of a remote camera of the present invention.

FIG. 2 is a perspective view of an extension line.

FIG. 3 is a top plan view showing a camera connecting with the extension line.

FIG. 4 is a perspective view of a conventional remote camera.

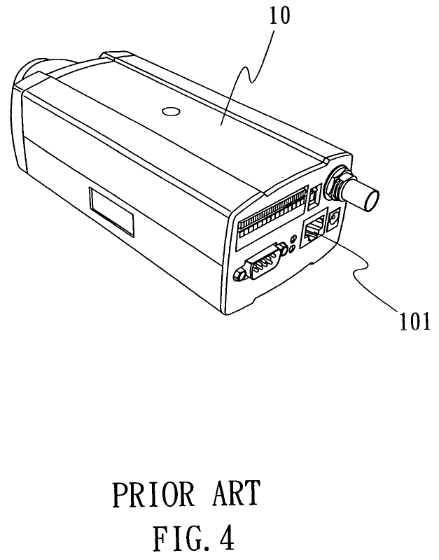

### DETAILED DESCRIPTION OF THE PREFERRED EMBODIMENTS

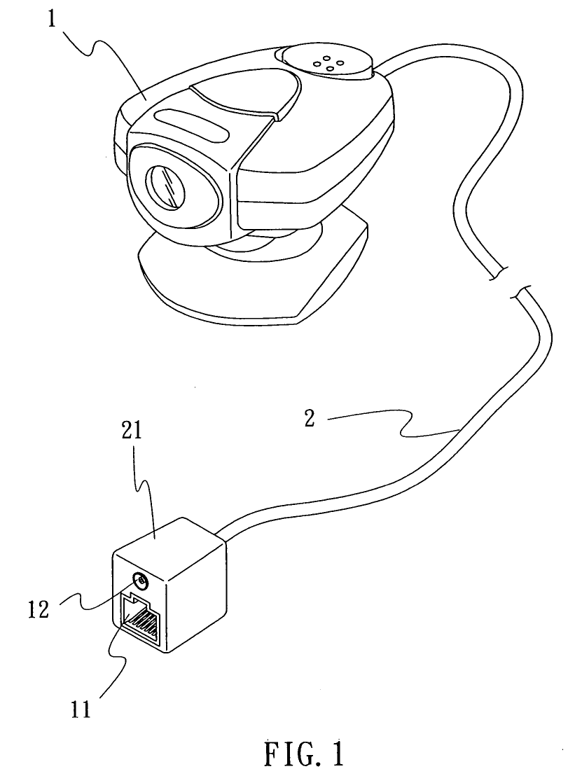

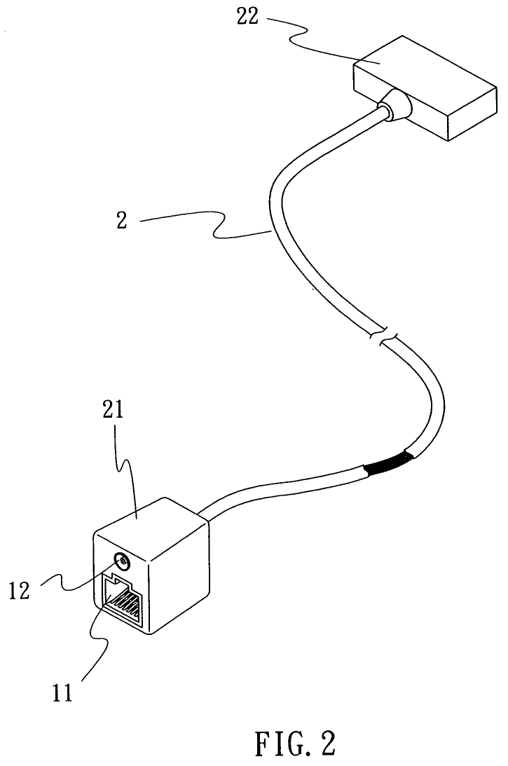

Referring to FIGS. 1-2, a connecting configuration of a remote camera of the present invention includes a camera 1 and an extension line 2 connected to a PCB 13 of the camera whereby an RJ-45 port 11 and a DC port 12 are separated from the PCB 13 of the camera 1. The PCB 13 is electrically connected with control modules (not shown) and lens of the camera 1. A connector 131 is formed at one side of the PCB 13.

The extension line 2 with a selected length and a plurality of cores has a housing 21 at one end thereof and a complementary connector 22 at the other end thereof. An RJ-45 port 11 and a DC port 12 are received in the housing 21 and are exposed to a selected surface of the housing 21. The RJ-45 port 11 and the DC port 12 are respectively connected to the cores of the extension line 2. Therefore, signals from the RJ-45 port 11 and the DC port 12 can be transmitted to the complementary connector 22 through the extension line 2.

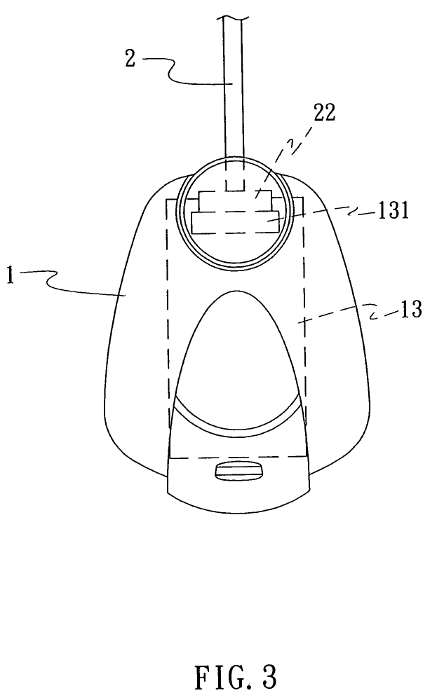

As shown in FIG. 3, the complementary connector 22 is connected to the connector 131 of the PCB 13 thereby transmitting the signals from the RJ-45 port 11 and the DC port 12 to the camera 1. Thus, the camera 1 can receive required power from the DC port 12 and transmit captured video data to the RJ-45 port through the extension line 2. Since the RJ-45 port 11 which is occupied relatively large space of the PCB is separated from the camera 1 through the extension line 2, the volume of the PCB 13 can be reduced and therefore the volume of the camera 1 can be reduced, which facilitates to control the camera 1 and to conceal the camera 1.

Furthermore, when the camera is installed in a ceiling or a high position, the connecting configuration of the remote camera of the present invention can also facilitate wiring, since a computer can connect with the remote camera through the housing 21 which may be installed at a low position or an easy reaching position. Moreover, the extension line 2 has functions of transmitting power and signals, which simplifies wiring.

It is understood that the invention may be embodied in other forms without departing from the spirit thereof. Thus, the present examples and embodiments are to be considered in all respects as illustrative and not restrictive, and the invention is not to be limited to the details given herein.

1. A connecting configuration of a remote camera, comprising a camera and an extension line connected to the camera, the camera having a PCB, a connector being disposed at the PCB, the extension line having a housing at one end thereof and a complementary connector at the other end thereof for connecting with the connector of the PCB, an RJ-45 port and a DC port being disposed in the housing and respectively connecting with the extension line, signals from the RJ-45 port and the DC port being transmitted to the connector of the PCB through the extension line, whereby the RJ-45 port and the DC port are separated from the camera for facilitating to reduce the volume of the camera.

2. The connecting configuration of the remote camera as claimed in claim 1, wherein the extension line has a selected length and a plurality of cores respectively connecting with the RJ-45 port and the DC port.

3. The connecting configuration of the remote camera as claimed in claim 1, wherein the RJ-45 port and the DC port are exposed to a surface of the housing.
